(19) United States
(12) Patent Application Publication
(10) Pub. No.: US 2016/0181751 A1
(43) Pub. Date: Jun. 23, 2016

(54) PLUG ELEMENT AND PLUG SYSTEM

(71) Applicant: BKS ENGINEERING AG, Derendingen (CH)

(72) Inventor: Walter AFFELTRANGER, Schenkon (CH)

(73) Assignee: BKS Engineering AG, Derendingen (CH)

(21) Appl. No.: 14/909,877

(22) PCT Filed: Aug. 20, 2014
(86) PCT No.: PCT/EP2014/067744

§ 371 Date: Feb. 3, 2016

(30) Foreign Application Priority Data
Aug. 20, 2013 (CH) 1417/13

(51) Int. Cl. H01R 33/76; H01R 24/28

(52) U.S. Cl. CPC H01R 33/7657; H01R 24/28; H01R 2107/00

(57) ABSTRACT

A plug element for an electrical contact of at least one electrical cable with plural electrical conductors includes a multi-part housing with a base element and at least one closure element and multiple contact pieces each including at least one plug contact for connecting an electrical conductor. A first group of at least one contact piece is allotted to a first service provided by the electrical conductors of a cable, and is assigned to a first formation of one or more chambers. At least one second group of at least one contact piece is allotted to at least one second service provided by a cable, and is assigned to at least one second formation of one or more chambers. A plug system includes a first plug element including male plug contacts and a second plug element including female plug contacts.

The present invention relates to a plug element for providing an electrical contact with at least one electrical cable comprising a plurality of electrical conductors and a plug system using such plug elements. In particular the plug element and the plug system are used to provide different services based on cable transmission to buildings.

Many services of modern technology provided for households, offices, etc. are transmitted by electrical cables, e. g. Internet, television, telephone, etc. Cables for the transmission of such services usually offer several leads, which end in a plug to be connected to a service recipient or a connection cable. Plugs for such service cables comprise a cable inlet and a contact unit with connectors for each of the leads extending from the cable inside the plug. Usually there is one plug for the transmission of one service. In case more services are requested, more such plugs can be merged to a plug assembly e. g. in one housing or one frame.

In EP 0809331 A1 a multipolar connector system is shown which provides connection to a service cable for providing an individual service. The system uses a multi-part housing which accommodates connector blocks in a block frame. The leads of a cable are connected to the contacts of the connector blocks in pairs. The blocks are positioned on the block frame and the frame allows access to the contacts on one side. The block frame in turn is enclosed by the housing to provide tension protection so that tension on a cable is not transferred to the leads. An outlet plug provides four connector blocks for four lead strands of the cable, which are pushed into the interior of a block frame. A connector plug provides a block frame with two mounting surfaces on which the connector blocks are mounted. Two housing halves are arranged around the block frame after the leads have been connected to the connector blocks and the blocks are positioned on the frame. The multipolar connector system is limited to provide electrical contact for a specified service. If further services are required, however, a second connector system has to be installed.

In EP 0731530 a connector assembly is shown in which a plurality of housings can be coupled to each other. The terminals of seven leads end in seven chambers of a main housing. For additional leads separate sub-housings are provided. Each sub-housing accommodates the terminals of two leads. The main housing comprises a coupling and a retainer mechanism to mount the sub-housings tightly on top of the main housing to realize the connector assembly. The connector assembly offers a flexible arrangement for a plurality of leads or lead strands. But the mounting of the assembly is complicated, and there is no indication as to how to arrange the multiple leads within the assembly.

It is an object of the invention to provide a plug element and a plug system which are flexible in combining different requirements for the wiring within a specific environment, such as a household or an electrical infrastructure for an office, the plug element and plug system being easy to mount, offering a simple set up and achieving a high safety standard.

These and further objects are solved by a plug element and a plug system according to the independent claims. Different alternatives and advantageous features of such a plug element and plug system are disclosed in the dependent claims.

A plug element providing an electrical contact with at least one electrical cable with a plurality of electrical conductors or leads according to the invention comprises a multi-part housing with a base element and at least one closure element, and multiple contact pieces each comprising at least one plug contact for connecting an electrical conductor of a cable. In most applications two electrical conductors are combined in one strand. Thus the contact pieces preferably comprise at least two plug contacts. The base element comprises multiple chambers provided for housing a contact piece in such a way that the plug contacts are accessible from a first side of the multi-part housing in a closed housing position. The first side generally corresponds to a front end of the plug element, which is plugged together with another plug element, jack, socket or the like. Thus the front side provides access to the plug element for electrical connection, and a contact exit of the plug element is realized. In this set up the contact pieces may define a longitudinal axis, wherein the front end is in general orthogonal to the axis and the electrical conductors in the contact pieces can be aligned basically parallel to the longitudinal axis.

The multi-part housing comprises a cable inlet for insertion of the at least one cable into the housing at a second side of the housing. The second side mostly corresponds to the end of the plug element opposite to the front end. But the second side can also be located at an angle to the first side, e. g. the second side can be orthogonal to the first side. Thus the cable can enter the housing at 90° relative to the longitudinal axis of the electrical conductors arranged in the contact pieces. In the following explanation of the invention, the second side of the housing shall be on an at least partially opposing side with respect to the first side. Preferably the second side runs generally parallel to the first side and orthogonal to the longitudinal axis. Thus the housing and a cable entering the housing also define a longitudinal axis of the plug element.

According to the invention, a first group of at least one, preferably two or more, contact pieces is allotted to a first service provided by the electrical conductors of a cable. The first group of at least one contact piece is assigned to a first formation of one or more chambers of the housing. Additionally at least one second group of at least one, preferably two or more, contact pieces is allotted to at least one second service provided by a cable, which may be the same cable as for the first service or may be a separate cable. The at least one second group of at least one contact piece is assigned to at least one second formation of one or more chambers of the housing. Thus the plug element is able to provide different services to an electrical infrastructure by using only one plug housing. The housing may simply be attached to the end of the cable, or it may be integrated into a rack, a wall structure or the like. Different cables for different services may comprise different numbers of electrical conductors. This can be addressed by the plug element in that a first service group and a second service group comprise a differing number of contact pieces. A formation of a chamber or chambers for a first service is defined by the specific arrangement of the contact pieces towards each other and also is defined by their position in relation to contact pieces of a second service.

Within the housing chambers all contact pieces of one group are orientated in the same manner, such that the terminals of the plug contacts are accessible from the first side, e. g. the front side of the housing. Preferably the contact pieces of all service groups are orientated in the same direction. But it is also possible for the chambers of the housing, which are provided for a set of contact pieces for one service, to have a different orientation within the housing than chambers that are provided for a set of contact pieces for another service. Thus the plug contacts are accessible from different sides of the plug element housing. For example the first service is provided from the front end of the housing and the second service is provided from a lateral side of the housing. Also contact exits provided by the plug contacts may be arranged at an angle towards a cable entering the housing through the cable inlet.

It is clear that there may be more than just one second service made available by the plug element according the invention. That means there may be a third, a fourth and so on group of contact pieces, that are assigned to a third, fourth and so on formation of housing chambers. The contact exits for all service groups are preferably orientated towards the same side, like the front end, of the housing. But also the contact exits may be located on differing housing sides.

A plug system according to the present invention comprises at least two plug elements as described above. A first plug element comprises male plug contacts. The male plug contacts extend from the contact pieces at the first side of the housing of the plug element. The housing may comprise extensions like a wall extending in the same direction to surround the contact pieces and offer protection. A second plug element comprises female plug contacts so that it is realized as a socket element. The first and second plug elements show groups of contact pieces and formations of contact pieces that are mirrored towards each other. Nevertheless not all of the contact pieces of the socket element have to be used for connection to one or more exiting cable of the socket element.

Preferably two plug elements of the plug system are connected along a longitudinal axis in direction of the electrical conductors. Thus the cables of each of the plug elements basically run along the longitudinal axis as well.

A plug element and a plug system according to the invention offer a great flexibility in providing electrical connection for different services. At the same time they allow a high safety standard, for example with respect to fire prevention, because the housing can easily be shielded and insulated. Furthermore the structure of the plug element offers easy assembling of the separate parts of the element. Also a rearrangement of the wiring within the housing is possible without any problems.

In one embodiment a plug element according to the invention comprises at least six contact pieces, each with two plug contacts, and at least six chambers, respectively. A first group includes for example four contact pieces. The four contact pieces may be organized in a square pattern. The four contact pieces can be provided e. g, for a gigabit-ethernet cable, which comprises four strands of two electrical conductors and therefore requires eight plug contacts. The other two contact pieces define the second group, and may be organized one above the other and next to the square pattern of the first group of contact pieces. Consequently the contact pieces of the plug element are arranged into lines of three pieces above each other. The second group of contact pieces may connect to a telephone service cable, which usually comprises two strands, each with two electrical conductors. The four strands of the Ethernet service may be bundled in a first cable, and the two strands of the telephone service may be bundled in a second cable. Also all six strands may be bundled in one single cable.

In general the plug elements of the invention are connected to electrical conductors of a cable providing an Ethernet service, a telephone service, as mentioned above, but also of cables providing television services, broadcasting services or any other service, that requires a plurality of electrical conductors.

It is advantageous to arrange all chambers of one group of contact pieces as a cluster, one next to the other, and to arrange the chamber clusters, one next to the other, in a line, for example. Thus a first formation of chambers and a second formation of chambers are divided by an imaginary, essentially straight, line through the overall arrangement of chambers. For example one group is given by chambers aligned in an upper row of chambers, and another group is given by chambers aligned in a lower row of chambers. The chamber clusters of course may also be arranged in square, triangle or other patterns.

The contact pieces can be provided with different kinds of plug contacts adapted for contacting different kinds of electrical conductors, e. g. for different service cables. Also, as mentioned above, the plug contacts can be realized as male and female plug contacts. Also each group of at least one contact piece can be marked with a color code. For example, a set of contact pieces for an Ethernet service may be dyed in a first color, and a set of contact pieces for a telephone service may be dyed in a second color. Of course the pieces of one group may have differing colors as well, to differentiate the separate electrical conductors of a cable.

In one embodiment of the invention the multiple contact pieces preferably are formed cube-like, and may comprise one elongated length. The multiple contact pieces comprise an inlet opening on a back side through which the electrical conductors of a cable enter the contact piece and at least one lateral opening, e. g, slits, providing access to the plug contacts inside the contact pieces. A front opening is provided on a front side for contact with another plug element or the like. Thus, the electrical conductors can be inserted through the back or lateral opening into the contact piece. In the case where the lateral opening and the back opening are conjoined, the conductors can easily slide in radial direction of the conductors into the contact piece from the side of the contact piece, and they do not need to be pushed into the piece in the direction of the electrical conductors. Pushing the electrical conductors usually entails a risk, for example that of damaging single filaments of the conductor. Within the contact piece the electrical conductors can be fixed in conventional manner. The plug contacts are accessible from the front opening, or the plug contacts may extend through the front opening.

To accommodate the contact pieces, the multiple chambers are preferably open toward at least two adjacent sides. That means the chambers are open for example from a back side and also from a lateral side or longitudinal side, so that one big insert opening ranging over both sides is realized, through which the contact pieces can be inserted into the chamber. In such embodiment the inlet opening and the lateral opening of the contact pieces correspond to the two adjacent open sides of the chamber. Additionally the chambers are at least partially open toward the front. When the contact pieces are inserted into the housing chambers, the front opening offers access to the plug contacts, while the back opening and lateral opening are free for insertion of electrical conductors into the contact pieces. Alternatively, the conductors can be inserted into the contact piece before placing the contact piece into the chamber.

In fact the design of the contact pieces as mentioned above is advantageous compared to contacting modules according to the prior art and it is useful also in case a plug element comprises only one contact piece or more than one contact piece for only one service. The conjoined openings for insertion of a conductor facilitate the insertion and proper arrangement of the conductor terminal within the contact piece. The conductor terminal is held in the opening by a corresponding cover area, e. g. on a closure element, as will be explained below, which assists the positioning of the conductor terminal within the contact piece and provides reliable contacting. Therefore the applicant reserves the right to focus a divisional patent application on the inventive design of the contact pieces of a plug element as described throughout the present application.

Preferably the multiple chambers are of equal dimension, and their shape is adapted with a custom fit to the dimension of the contact pieces. The contact pieces may be fixed in the chambers by a press-fitting and friction-locking, or they can be glued in or fixed by mechanical locking. Preferably the contact pieces are detachably held in the chambers, e. g. by friction-locking, so that the electrical conductors or the contact pieces can be inspected or changed easily.

The multiple chambers can be arranged in a symmetrical pattern at the base element. For example, the base element comprises a separation wall orientated along a longitudinal axis of the plug element and separating a first row of chambers provided on an upper side of the separation wall and a second row of chambers provided on a lower side of the separation wall. In this case the joined insert openings of the chambers of the two rows are orientated symmetrically away from the separation wall.

In one embodiment of a plug element, the housing comprises two closure elements attached on opposite sides of the base element by hinged connections such that, in a closed position of the closure elements, the base element is enclosed. The front sides of the contact pieces are left uncovered to provide access to the plug contacts. The two closure elements basically are attached wing-like in the form of closure wings to the base element. They may be pivoted symmetrically but independently from each other relative to the base element. Thus a first row of chambers on one side of the base element can be closed independently from a second row of chambers on another side of the base element. Also just one of the closure wings can be opened. That means a first group of at least one contact piece can be covered by a first closure element, and a second group of at least one contact piece can be covered by a second closure element. Also one group can be uncovered, while the other group is covered. In a completely open position of the closure elements, both closure wings are pivoted away from the base element, and can for example extend about 90° from the longitudinal axis of the base element and the contact pieces respectively. In a closed position, both closure wings cover the chambers of the base element; basically they are aligned parallel towards each other and towards the longitudinal axis. In the closed position, preferably the inner volume of the multipart housing is occupied only partly by the base element. The remaining space may be used for storage of the one or more cables or other elements.

The closure elements may comprise cover areas on their inside covering the lateral openings of the contact pieces in a closed position. The cover areas may comprise extensions reaching into the lateral openings of the contact pieces in a closed position of the housing. The extensions can serve as a fixation of the electrical conductors, when the conductors are pressed into the plug contacts. The cover areas and/or extensions also can serve as insulation of the contact plugs.

In a closed position, the closure elements together may form at least one cable inlet for at least one cable. The cable inlets may be located on the closure elements opposite to the end comprising the hinged connection. The cable inlets can be realized by half-shells in a circumferential wall of the closure elements. In a closed position, the half shells of the two opposing closure elements lay on top of each other, and together form a tube-like opening into the housing. For more than one cable, the closure elements may comprise more than one half shell, e. g. next to each other or on different sides of the closure elements.

The closure elements also can provide tension protection for the electrical conductors, in that a clamping or abutment mechanism is arranged. In a closed position of the closure elements, first elements of the mechanism and second elements of the mechanism co-operate with each other to hold on to the cable tightly in the direction away from the plug element. So a pulling force is not transmitted to the electrical conductors. A first element may be realized by an abutment strip on a base surface of the closure element, and a second element may be realized by a wall or an edge of the base element.

A plug element and a plug system according to the present invention offers a flexible and individual configuration of electrical conductors for different requirements within one housing. The electrical connection can easily be established by simply mounting the electrical conductors of different services in groups in the base element and pivoting the closure elements towards one another. A locking mechanism, such as a snap lock, may lock the closure elements with respect to one another. The wiring can easily be replaced or changed by unlocking and opening the closure elements and disconnecting the electrical conductors or removing the contact pieces.

The plug element and the plug system are particularly advantageous for electrical connections. But the structure also offers an improvement to optical connectors, in particular the structure of a multi-part housing and multiple contact pieces as well as dividing a plurality of connectors into more than one group of connectors according to the function of the connectors.

A plug element according to the invention will be described in more detail together with the accompanying drawings. Details and features of the invention depicted in the figures shall contribute to the disclosure of the invention, but are not meant to limit the invention in any way. The drawings are:

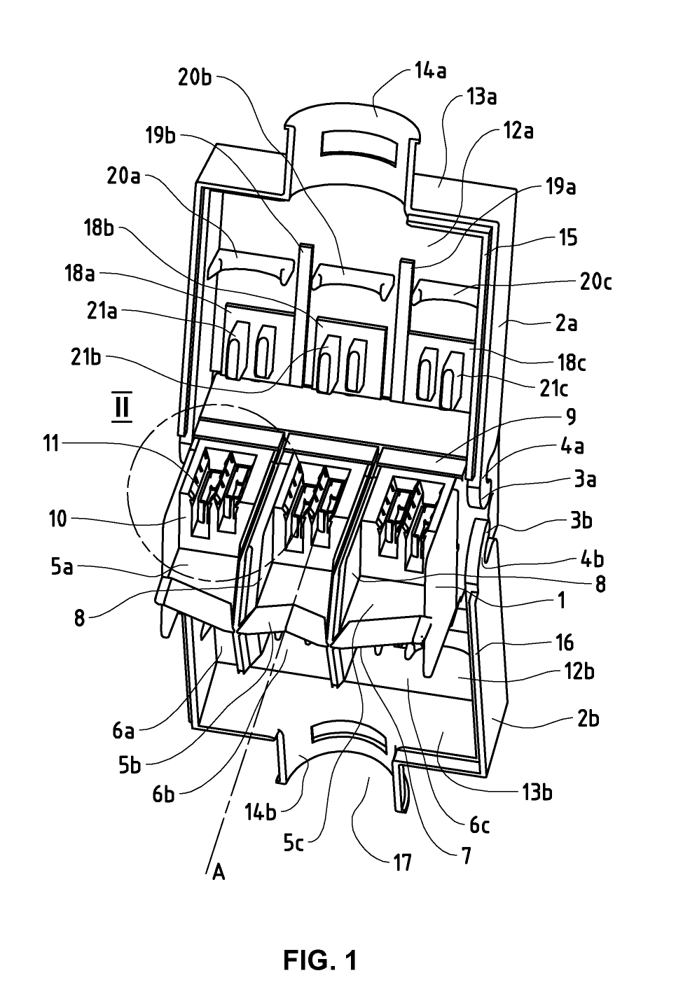

FIG. 1: a perspective view of a plug element according to the invention in an open position seen from the inside,

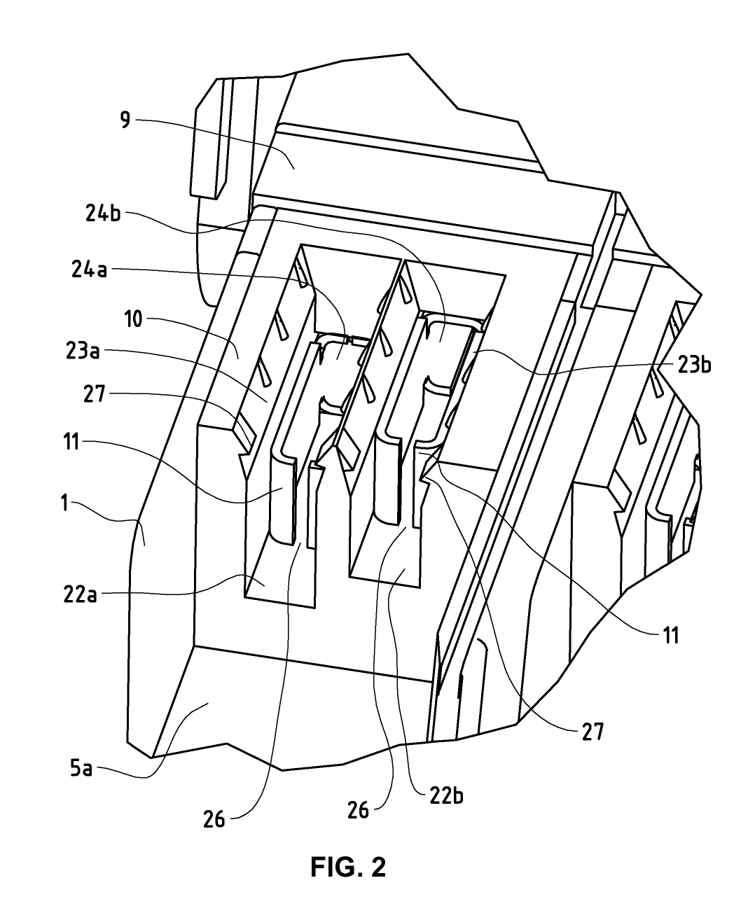

FIG. 2: a detailed perspective view of detail A of FIG. 1 showing a contact piece in a chamber of a base element,

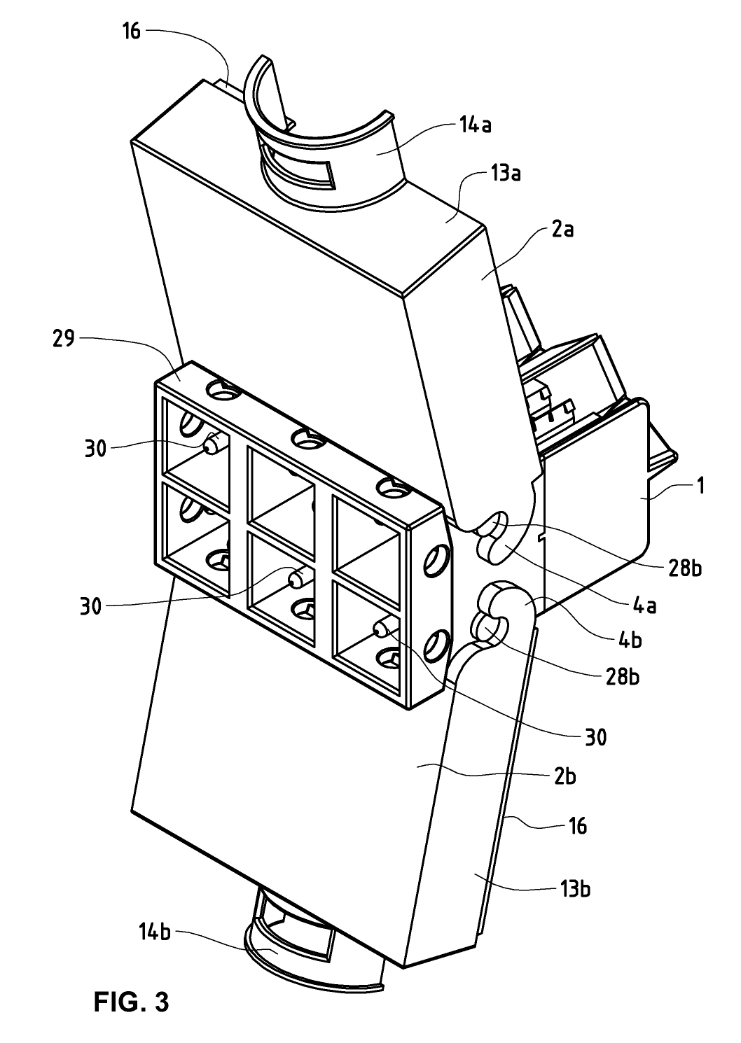

FIG. 3: a perspective view of the plug element in an open position seen from the outside,

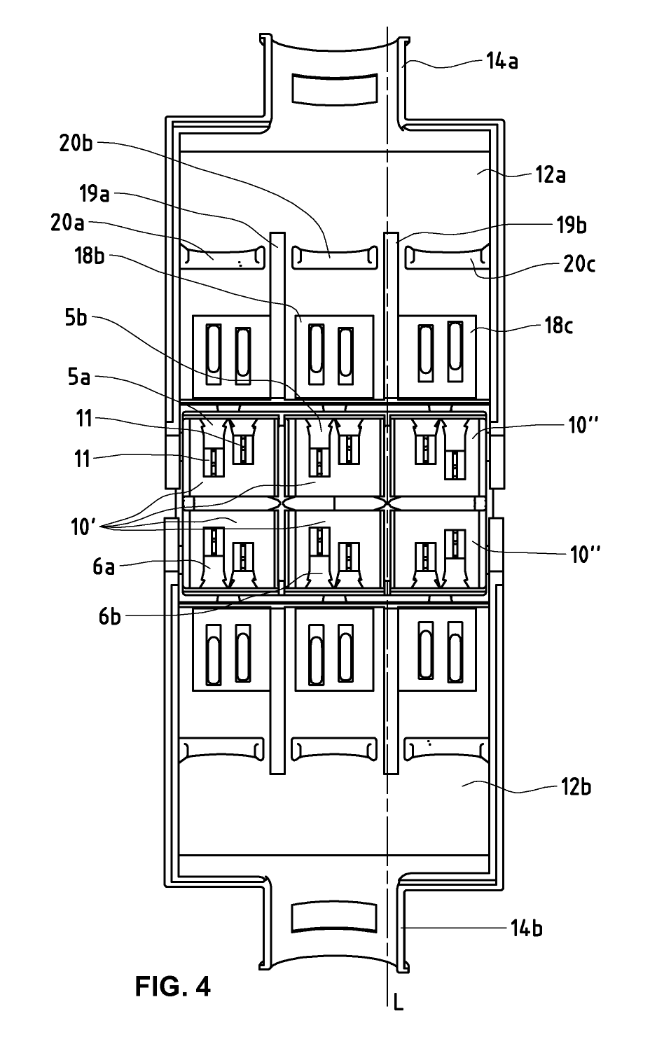

FIG. 4: a front view of the plug element in an open position seen from the inside, and

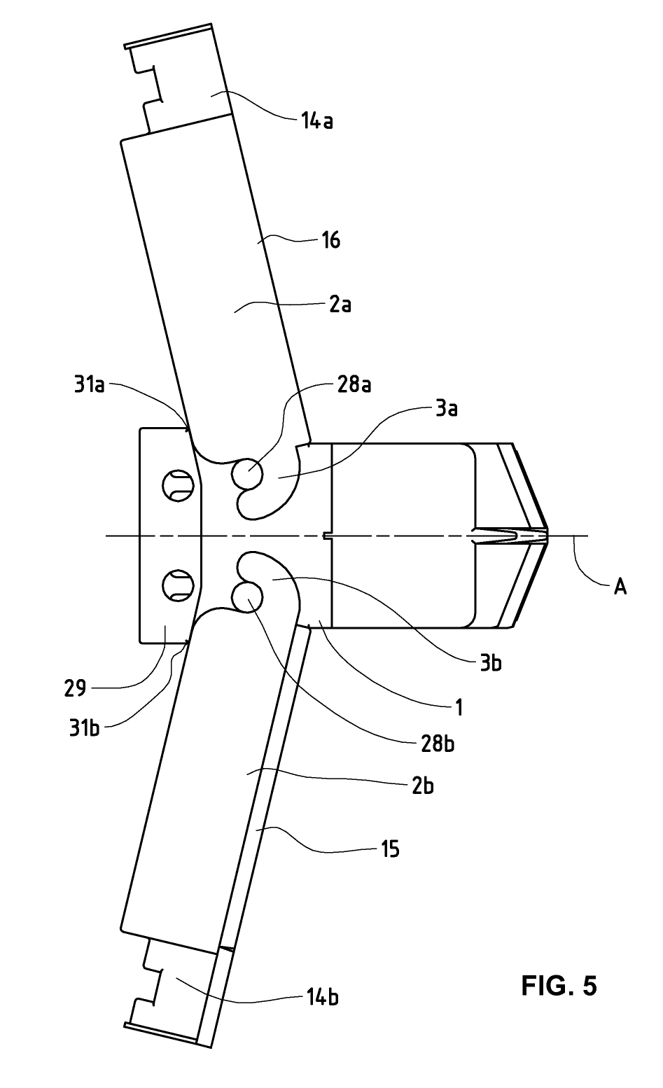

FIG. 5: a side view of the plug element in an open position.

FIGS. 1-5 show one embodiment of a plug element according to the invention. The plug element can be part of a plug system according to the invention. A complementary plug element of the plug system basically may have the same structure with little adaptation to realize an electrical and mechanical connection with the shown plug element as basically known to a person skilled in the art.

As shown in FIG. 1, the plug element comprises a multi-part housing with a base element 1 and a first closure element 2a and a second closure element 2b. The closure elements 2a and 2b are attached on opposite sides of the base element 1 by hinged connections 3a and 3b. The base element 1 and the closure elements 2a and 2b may be made of suitable plastic material, for example by injection molding. The hinged connections 3a and 3b can be realized for example by a pair of curved fingers 4a and 4b extending symmetrically on opposite sides of closure elements 2a and 2b. The base element 1 may comprise short buttons 28 (see FIG. 3), extending from two opposing sides, to which the closure elements will be attached. The curved fingers 4a and 4b surround the buttons such that the base element 1 is located and hung up in between the opposing fingers in the closure elements 2a and 2b.

The base element 1 comprises multiple chambers 5 and 6 arranged in a first row of three chambers 5a, 5b, 5c and a second row of three chambers 6a, 6b, 6c. The first row of chambers 5 is arranged parallel to the second row of chambers 6. A separation wall 7 separates the first and second rows of chambers 5 and 6. Each of the chambers in one row is divided by side walls 8. The chambers 5 and 6 are of the same size in length, width and depth. The orientation of the chambers 5 and 6 define a longitudinal axis A of the plug element with the rows of the chambers running perpendicular to the longitudinal axis A. The row of chambers 5 is mirror-symmetrical to the row of chambers 6 with respect to the separation wall 7.

The chambers 5 and 6 are limited by the separation wall 7 and the side walls 8. That means the chambers 5 and 6 are open toward the front, toward the back and at one lateral side. In FIG. 1, the open lateral side for the chambers of row 5 is the upper side, and for chambers of row 6 the bottom side. For chamber row 5, the upper side and the back side, and for chamber row 6, the bottom side and the back side define adjacent open sides creating one big insert opening. In the direction of the front side, the open lateral sides may be bridged by a flat bar 9.

Each of the six chambers 5a, 5b, 5c and 6a, 6b, 6c houses a contact piece 10 comprising a plug contact 11, which will be explained in more detail in FIG. 2.

The closure elements 2a and 2b have the shape of a bowl with a base surface 12a and 12b and a circumferentially surrounding wall 13a and 13b. The curved fingers 4a and 4b are located in each of the corners of the front side. In the back side, opposite to the front side, half-shells 14a and 14b are integrated in the surrounding walls 13a and 13b. The closure elements 2a and 2b comprise an inner rim 15 along a longitudinal side and an outer rim 16 along the opposing longitudinal side at the edges of the surrounding walls 13a and 13b. The inner rim 15 of closure element 2a is complementary to the outer rim 16 of closure element 2b, and vice versa. In closed position, not shown, the inner rim 15 and the outer rim 16 overlap and seal the multi-part housing of the plug element. Also in the closed position, the rims 15 and 16 can serve as a locking mechanism such that they create a friction lock for the housing. Preferably a snap lock mechanism is integrated in the surrounding walls 13a and 13b, which establishes a positive locking of the closure elements 2a and 2b as is known in the state of the art. The locking mechanism is preferably able to be reopened again.

In the closed position the two half-shells 14a and 14b, they create together a cable inlet 17 at the rear end of the plug element. The cable inlet 17 realized by the two half-shells 14a and 14b extends along the longitudinal axis A, and stabilizes a cable, which shall be inserted into the plug element.

At the inside of base surfaces 12a and 12b, the closure elements 2a and 2b comprise cover areas 18a, 18b, 18c, abutment strips 19a, 19b, and clamp bars 20a, 20b, 20c. Extensions 21a, 21b, 21c extend from the cover areas 18a, 18b, 18c in the direction of the contact pieces 10. In a closed position, the extensions 21a, 21b, 21c reach into openings of the contact pieces 10, as will be explained later. The abutment strips 19a, 19b rest on the side walls 8 and seal the chambers relative to each other in a closed position. The clamp bars 20a, 20b, 20c clamp the cable or electrical conductors of cables between themselves and the separation wall 7 of base element 1.

FIG. 2 shows in detail a contact piece 10 positioned in chamber 5a of the base element 1. The contact piece 10 comprises two inlet openings 22a and 22b on a back side, two lateral openings 23a and 23b on a lateral side, and front openings 24a and 24b on a front side of the contact piece 10. The inlet openings 22a and 22b and the lateral openings 23a and 23b together form a slit in the contact piece, which in the shown example of a contact piece is open to the back and the upper lateral side. In the shown example the left slit extends deeper into the contact piece 10 than the right slit. In the openings or slits respectively plug contacts 11 are provided for mounting terminals of an electrical conductor. The plug contacts 11 comprise a slit 26 at the back to grab the terminals of an electrical conductor. The slit 26 of the plug contacts 11 is aligned with the inlet opening on the back side. The plug contacts are open towards the lateral side, so that a conductor terminal can easily slide into the slit 26 from the lateral side. The lateral opening corresponds to the lateral opening 23 of the contact piece and is connected with the slit 26. The plug contacts 11 can be realized as a metal cramp, which are placed in the conjoined back and lateral openings of the contact piece. On the front side the plug contacts 11 may be designed as male plug contacts with male extensions 30 (see FIG. 3) or as female plug contacts. In the case of male plug contacts, extensions 30 reach through the front openings 24a and 24b and out of the base element 1. In the case of female plug contacts, holes are established at the front end of plug contacts 11, which allow insertion of a male contact.

The lateral openings 23a, 23b comprise little hooks 27 extending to the inside of the opening. The hooks 27 can interact with counterparts on the extensions 21 of the cover areas 18 to lock the lateral openings of the contact pieces 10 and at the same time lock the closure element 21a to contact piece 10. The hooks act like a snap connection, which can be released by applying some force on the connection.

The contact pieces 10 basically are attached to the base element 1 by friction between the walls of the contact pieces 10 and the walls of the chambers 5 and 6 of base element 1. Of course the contact pieces could also be glued into the chamber or mechanically attached thereto. The flat bar 9 also may support the positioning of the contact pieces 10 within the chambers 5 and 6 of the base element 1. The inlet openings 22a and 22b are orientated in a way analogous to the open back side of the chamber 5a, and the lateral openings 23a and 23b are orientated in a way analogous to the open lateral side of the chamber 5a. The front openings 24a and 24b are aligned with the open front side of chamber 5a. Thus electrical conductors can easily be introduced into slits 26 of the plug contacts 11 when the contact piece 10 is already inserted into chamber 5a. Alternatively, electrical conductors can be inserted into slits 26 before the contact piece 10 is placed in the chamber 5a.

The contact pieces 10 generally have the shape of a cube, wherein the length of the longitudinal side is larger than the front or back side. The contact pieces 10 may be made of plastic and produced e. g. by injection molding. The plug contacts 11 are generally made of electrically conducting material, such as metal, to connect with the electrical conductors of a cable.

In FIG. 3, the plug element is shown in an open position seen from the outside and with a partial front view. The closure elements 2a and 2b are attached to the base element 1 in that the curved fingers 4a and 4b pivotably surround the buttons 28a and 28b. The base element 1 comprises an apron 29 that extends on the outer side of the closure elements 2a and 2b. The apron 29 creates an abutment, against further opening, for the closure elements 2a and 2b in the open position. The apron 29 encircles the open front sides of chamber 5 and 6 (not shown in FIG. 3) and extends over male extensions 30 of plug contacts 11 located in the contact pieces 10. The apron 29 also may serve as connecting element for the connection with another plug element of a plug system.

In FIG. 4, the plug element according to the invention is show in an open position permitting a view on the back side of the six contact pieces 10 in the upper row of chambers 5 and the lower row of chambers 6. A first group of four contact pieces 10′ is assigned to a first formation of chambers 5a, 5b, 6a and 6b, which formation corresponds to a square pattern or two rows of two contact pieces above each other. The group of four contact pieces 10′ comprises in each case two plug contacts 11. The eight plug contacts 11 of the four contact pieces 10′ are provided to receive eight electrical conductors of a cable, which provides an Ethernet service. A second group of two contact pieces 10″ is assigned to a second formation of two chambers 5c and 6c in the form of a vertical arrangement above one another or in the form of a column arrangement. The group of two contact pieces 10″ provides four plug contacts 11, which are provided to receive four electrical conductors of the cable, which provide a telephone or television service. In this case the electrical conductors for the Ethernet service and the telephone/television service are bundled in one cable.

The group of four contact pieces 10′ and the group of two contact pieces 10″ is separated by a straight imaginary vertical line L running between the chambers 5b, 6b and 5c, 6c. The contact pieces 10′ of the first group for the Ethernet service can be dyed in a first color and the contact pieces 10″ of the second group for the telephone/television service can be dyed in a second color, different from the first color.

In the case of another alternative of a plug element of the invention, a different allocation of the contact pieces 10 may be required. For example, if two services, each with six electrical conductors, are requested, two groups of three contact pieces 10 may be set up. For example, a first group is represented by the upper row of contact pieces in chambers 5a, 5b and 5c, and a second group is represented by the lower row of contact pieces in chambers 6a, 6b and 6c. In this case an imaginary horizontal line divides the two groups of contact pieces.

In FIG. 5 the plug element is shown from a side view. The longitudinal axis A extends from the front end on the left side to the back end on the right side and through the separation wall (not shown) of base element 1. The base element 1 with the apron 29 and the attached closure elements 2a and 2b is symmetrical to the longitudinal axis A. The closure elements 2a and 2b abut against the apron 29 at abutment points 31a and 31b in the opened position shown. To close the plug element, the closure elements 2a and 2b are pivoted around the buttons 28a and 28b until the inner rim 15 and the outer rim 16 engage with each other and the abutment strips 19a and 19b abut against the side walls 8 of the chambers of base element 1 (see FIG. 1). In the fully closed position, the closure elements 2a and 2b run parallel to each other and are arranged in a way symmetrical to axis A. The plug contacts 11 are accessible from a first side, which is the front end, and the cable is to be inserted at a second side, which in this embodiment is the back end. Of course the closure elements 2a and 2b can be pivoted individually or separately from one another to open or close just one side or one row of the base element 1.

The inventive idea has been described for one embodiment according to FIGS. 1 to 5. But it is clear to a person skilled in the art that variations and alternatives to the described embodiment are obvious. For example, the base element may comprise more than two rows of chambers, and the contact pieces may comprise more than two plug contacts. The closure elements could be arranged to be slidable instead of pivotable, and so on.

1-17. (canceled)

18. A plug element for an electrical contact of at least one electrical cable with a plurality of electrical conductors, comprising:
a multi-part housing including a base element and at least one closure element; and
multiple contact pieces each comprising at least one plug contacts for connecting an electrical conductor;
wherein the base element comprises multiple chambers for housing a contact piece such that the plug contacts are accessible from a first side of the multi-part housing in a closed housing position;
wherein the multi-part housing comprises a cable inlet for insertion of the at least one cable into the housing at a second side of the housing;
wherein the multiple chambers are open toward at least two adjacent sides for insertion of contact pieces and/or electrical conductors;
wherein a first group of at least one contact piece is allotted to a first service provided by the electrical conductors of a cable, wherein the first group of at least one contact piece is assigned to a first formation of one or more chambers; and
wherein at least one second group of at least one contact piece is allotted to at least one second service provided by a cable, wherein the at least one second group of at least one contact piece is assigned to at least one second formation of one or more chambers.

19. A plug element according to claim 18, wherein the plug element comprises at least six contact pieces and at least six chambers, respectively.

20. A plug element according to claim 18, wherein the plug contacts of a group of at least one contact piece are connectable to electrical conductors of a cable providing an Ethernet service, a television service, a telephone service, or broadcasting services.

21. A plug element according to claim 18, wherein a first formation of chambers and a second formation of chambers is divided by an imaginary straight line through an overall arrangement of chambers.

22. A plug element according to claim 18, wherein different of the contact pieces include different kinds of plug contacts adapted for contacting different kinds of electrical conductors.

23. A plug element according to claim 18, wherein the multiple chambers are of equal size.

24. A plug element according to claim 18, wherein the multiple contact pieces comprise an inlet opening on a back side through which the electrical conductors may enter the contact piece, at least one lateral opening providing access to the plug contacts inside the contact pieces, and a front opening on a front side.

25. A plug element according to claim 24, wherein the lateral opening and the inlet opening are conjoined.

26. A element according to claim 24, wherein the plug contacts are provided within the inlet opening, which comprise a slit on a back side and a lateral opening connected with the slit.

27. A element according to claim 18, wherein each group of at least one contact pieces is marked with a color code.

28. A element according to claim 18, wherein the housing comprises two closure elements attached on opposite sides of the base element by hinged connections such that in a closed position of the closure elements the base element is enclosed with the front side of the contact pieces left uncovered.

29. A element according to claim 18, wherein the base element comprises a separation wall orientated along a longitudinal axis of the plug element and separating a first row of chambers provided on an upper side of the separation wall and a second row of chambers provided on a lower side of the separation wall.

30. A element according to claim 18, wherein the closure elements comprise cover areas on their inside covering the lateral openings of the contact pieces in a closed position.

31. A element according to claim 30, wherein the cover areas comprise extensions reaching into the lateral openings of the contact pieces in a closed position of the housing.

32. A element according to claim 18, wherein the closure elements in a closed position together form at least one cable inlet for at least one cable.

33. A system comprising at least two plug elements according to claim 18, wherein a first plug element comprises male plug contacts and a second plug element comprises female plug contacts.

34. A system according to claim 33, wherein the two plug elements are connected along a longitudinal axis in direction of the electrical conductors.
